(19) United States
(12) Patent Application Publication
(10) Pub. No.: US 2025/0377557 A1
(43) Pub. Date: Dec. 11, 2025

(54) MODIFICATION OF THE OPTICAL PROPERTIES OF AN EXISTING CONTACT LENS WITH AN OPHTHALMIC LENS LATHE

(71) Applicant: UNIVERSITY OF HOUSTON SYSTEM, Houston, TX (US)

(72) Inventors: Jason Marsack, Houston, TX (US); Alex Schill, Houston, TX (US); Lan Chi Nguyen, Manvel, TX (US); Raymond Applegate, Kingwood, TX (US); Nasim Maddah, Houston, TX (US)

(73) Assignee: UNIVERSITY OF HOUSTON SYSTEM, Houston, TX (US)

(21) Appl. No.: 18/877,887

(22) PCT Filed: Jun. 21, 2023
(86) PCT No.: PCT/US2023/025842

§ 371 Date: Dec. 20, 2024

Related U.S. Application Data
(60) Provisional application No. 63/353,966, filed on Jun. 21, 2022.

(51) Int. Cl. G02C 7/02; G02C 7/04

(52) U.S. Cl. CPC G02C 7/027; G02C 7/04; G02C 2202/22

(57) ABSTRACT

Embodiments of the present disclosure pertain to methods of customizing a pre-manufactured contact lens for a user by evaluating the conformance of a pre-manufactured contact lens to the user's eye profile (e.g., quantifying eye aberrations of the user's eye profile while the lens is worn) and conforming one or more optical properties of the pre-manufactured contact lens or a duplicate thereof to the user's eye profile based on the evaluation. In some embodiments, the conforming includes mounting the pre-manufactured contact lens on a contact lens mount and altering one or more optical properties of the pre-manufactured contact lens on the contact lens mount. Additional embodiments of the present disclosure pertain to systems for customizing a contact lens. Such systems include a convex contact lens mount with a base area operational for anchoring the convex contact lens mount, and a convex surface operational to mount the pre-manufactured contact lens.

### CROSS-REFERENCE TO RELATED APPLICATIONS

This application claims priority to U.S. Provisional Patent Application No. 63/353,966, filed on Jun. 21, 2022. The entirety of the aforementioned application is incorporated herein by reference.

### BACKGROUND

The vast majority of commercially available contact lenses incorporate spherical or sphero-cylindrical optical power into the design of the lens. These commercially available contact lenses do not have the ability to target other visually important aberrations (referred to herein as higher-order aberrations). For the small number of commercially available contact lenses that do allow for the targeting of higher-order aberrations (referred to herein as custom lenses), the process that is required to deliver custom lenses to the patient in the eye clinic imposes significant limitations on the custom lens manufacturer, the doctor, and the patient, all of which reduce the clinical availability of custom lenses. Numerous embodiments of the present disclosure address the aforementioned limitations in the process required to produce a custom lens. These limitations are addressed by employing a novel method that alters an existing, “off the shelf” pre-manufactured spherical or pre-manufactured sphero-cylindrical contact lens in a manner that results in that lens being transformed into a custom lens. This differs significantly from the current state of the art for manufacture of custom lenses, which requires that all spherical, sphero-cylindrical and higher-order aberration optical power be integrated into the design of the lens prior to lens manufacture.

### SUMMARY

In some embodiments, the present disclosure pertains to methods of customizing a pre-manufactured contact lens for a user. In some embodiments, the methods of the present disclosure include: evaluating the conformance of a pre-manufactured contact lens to the user's eye profile; and conforming one or more optical properties of the pre-manufactured contact lens or a duplicate thereof to the user's eye profile based on the evaluation. In some embodiments, the conforming includes mounting the pre-manufactured contact lens on a contact lens mount; and altering one or more optical properties of the pre-manufactured contact lens on the contact lens mount.

In some embodiments, the methods of the present disclosure include one or more steps of: selecting a pre-manufactured contact lens; placing the pre-manufactured contact lens on a user's eye; evaluating the conformance of the pre-manufactured contact lens to the user's eye profile (e.g., by quantifying one or more eye aberrations of the user's eye profile-such as residual optical aberrations—while the user is wearing the pre-manufactured contact lens); mounting the pre-manufactured contact lens on a contact lens mount; constructing a digital model of the pre-manufactured contact lens; inserting the contact lens mount into an ophthalmic contact lens lathe; altering one or more optical properties of pre-manufactured contact lens based on the evaluation (e.g., based on the measured optical deficits of the lens/eye combination); and removing the customized contact lens from the contact lens mount. In some embodiments, the customized contact lens may then be placed back on the user's eye for further evaluation of the conformance of the contact lens to the user's eye profile. Thereafter, one or more steps of the methods of the present disclosure may be repeated to further customize the pre-manufactured contact lens.

Additional embodiments of the present disclosure pertain to systems for customizing a contact lens. In some embodiments, the systems of the present disclosure include a convex contact lens mount. In some embodiments, the convex contact lens mount includes a base area operational for anchoring the convex contact lens mount, and a convex surface operational to mount the pre-manufactured contact lens.

In some embodiments, the convex contact lens mount also includes a protruded area positioned between the base area and the convex surface. In some embodiments, the protruded area includes a protruded edge that surrounds the convex surface. In some embodiments, the convex contact lens mount also includes a layer positioned on the protruded edge. In some embodiments, the layer is operational to facilitate the mounting of the pre-manufactured contact lens on the convex surface. In some embodiments, the layer is in the form of a ring.

In some embodiments, the systems of the present disclosure also include an interferometer that is operational to align the pre-manufactured contact lens on the convex contact lens mount by interferometry. In some embodiments, the systems of the present disclosure also include an ophthalmic contact lens lathe.

### BRIEF DESCRIPTION OF THE DRAWINGS

FIGS. 1A and 1B illustrate methods of customizing pre-manufactured contact lenses.

FIGS. 2A-2F provide various illustrations of contact lens mounts.

FIGS. 3A-3C provide illustrations of interferometers for confirming the placement of the pre-manufactured contact lenses on contact lens mounts.

FIG. 4 provides an illustration of a contact lens lathe for altering optical properties of pre-manufactured contact lenses.

FIG. 5 provides a comparison of optical properties (Zernike terms) for custom lenses manufactured in accordance with existing methods and the methods of the present disclosure.

FIG. 6 illustrates a 3-dimensional digital point cloud that represents a scanned surface of a pre-manufactured contact lens.

FIG. 7 illustrates a reconstructed three-dimensional representation of a pre-manufactured contact lens generated by a custom software application (“App”) using the interpolation of data points measured by a scanner.

FIG. 8 provides a snapshot of the graphical user interface of the App.

FIG. 9 illustrates a two-dimensional sampling grid used by the App to reconstruct a 3D representation of a pre-manufactured contact lens.

FIG. 10 provides an example of the output file, also known as a VOI file, produced by the App and containing the requisite header information and data formatting used by the ophthalmic lens lathe to implement intended modifications to a pre-manufactured contact lens surface profile.

### DETAILED DESCRIPTION

It is to be understood that both the foregoing general description and the following detailed description are illustrative and explanatory and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials define a term in a manner that contradicts the definition of that term in this application, this application controls.

Contact lenses are used to correct refractive errors of the eye. There are two primary forms of contact lenses: soft contact lenses and rigid contact lenses. Soft contact lenses are made of flexible materials that take the shape of the cornea when worn. Rigid contact lenses have a pre-defined shape and, to a large extent, hold their shape when worn on the eye. Rigid lenses can be further broken down into corneal lenses and scleral lenses. Rigid corneal lenses are designed to touch the cornea when worn, and their diameters are typically less than that of the cornea. Rigid scleral lenses bear their weight on the conjunctiva that covers the sclera. They generally do not touch the cornea, and their diameter is typically greater than that of the cornea.

The optical portions of soft contact lenses and rigid contact lenses are designed such that they compensate for spherical and cylindrical refractive errors of the eye. For example, a contact lens (e.g., soft or rigid contact lenses) may be designed to correct 2.00 diopters of spherical error and 1.00 diopter of cylindrical error in an eye. Importantly, these corrections are delivered in discrete steps, typically 0.25 diopter steps of sphere and 0.50 diopter steps of cylinder for soft contact lenses, and 0.25 diopter steps of sphere and 0.25 diopter steps of cylinder for rigid contact lenses. Hence, an individual may be able to get a contact lens with 2.00 diopters of sphere power, and the next level of available sphere power would be cither 2.25 or 1.75 diopters of sphere power.

Beyond sphere and cylinder, eyes suffer from additional optical deficits caused by elevated residual higher-order aberrations. However, such higher-order aberrations are typically not considered in contact lens practice because they are not measured in the typical contact lens clinic.

The aforementioned discretizing of the sphere and cylinder correction steps, coupled with ignoring the presence of higher-order aberrations, is done in soft contact lenses to limit the contact lenses that must be manufactured in any given set by any given manufacturer. In rigid contact lenses, these optical step sizes are chosen to match the clinical measurements that are taken in prescribing them.

The aforementioned discretizing causes eyes, regardless of whether the eye is wearing a soft contact lens or a rigid contact lens, to experience residual uncorrected refractive errors. The limitations imposed by delivering optical correction in discrete steps are, to some degree, counterbalanced by the availability of both soft contact lenses and rigid contact lenses, and the ease of fitting both soft contact lenses and rigid contact lenses in the clinic.

For instance, the University Eye Institute at The University of Houston College of Optometry has thousands of trial soft contact lenses in pre-packaged form and hundreds of rigid contact lenses in trial contact lens kits. This allows a clinician to evaluate a patient in the clinic and immediately choose a contact lens to try on the eye (they can pull it from the on-site trial contact lenses or contact lens fitting sets). If the contact lens is judged satisfactory, the clinician can prescribe the contact lens for routine use as specified in the product labeling, which would entail a clinician ordering duplicates of the soft contact lens for everyday wear, or a duplicate or near duplicate (with minor modification) of the rigid contact lens for everyday wear.

However, the aforementioned methods of delivery of contact lenses will leave uncorrected optical deficits in all eyes. While customization of contact lenses to include compensation for eye-specific levels of residual aberration (e.g., sphere, cylinder and/or higher-order aberrations) has been suggested since the 1960 s and has been studied and demonstrated since at least 2007, it is still not widely available in the clinic, leaving a significant segment of the population underserved.

The previously demonstrated methods for customizing a contact lens to the needs of an individual eye are varied, but are predominantly built on a process that requires the manufacture of two contact lenses—1) the trial contact lens and 2) the customized contact lens. For instance, in the previously demonstrated processes, as well as all current commercially available custom contact lens processes, that integrate both residual sphero-cylindrical and higher-order aberration correction into a contact lens, a trial contact lens would be worn on an eye, and the residual uncorrected aberrations would be measured through that trial contact lens. This residual aberration data is then integrated into the computer design of the trial contact lens, which defines a new, custom contact lens. Thereafter, a second contact lens (the customized contact lens) is produced. The second customized contact lens mimics the trial contact lens in all aspects, except that it also includes the compensation of the individual eye's residual uncorrected aberrations (residual sphere, cylinder, and higher-order aberrations) that were measured through the trial contact lens. This process, which requires two contact lenses, is limiting in at least two important ways.

First, the majority of contact lenses available today in the clinic do not allow for the integration of residual uncorrected aberrations, meaning most contact lenses available today do not offer an option to integrate the residual aberration correction into the contact lens. This means that a patient who is satisfied with the comfort, wear time, cost, and any other non-optical aspects of their current contact lens, but is in need of improved aberration correction to improve the quality of vision through customization, must change their contact lens to one of the very few contact lenses that offer the integration of residual aberration correction. This may result in the patient's dissatisfaction with contact lens comfort, wear time, cost, and any other non-optical aspects of the contact lens at the expense of better optical performance for improved vision.

Second, the current process for contact lens customization requires a manufacturer to build two contact lenses (both the trial contact lens and the custom contact lens). The trial contact lens is only used as a stepping stone to the custom contact lens, and will typically only be worn 1 time. Therefore, the process is inefficient.

The method and system described in the present disclosure address both of these shortcomings of the current customization process. By customizing a previously manufactured (or pre-manufactured) contact lens (e.g., spherical or sphero-cylindrical contact lens), any contact lens available in the clinic can become a custom contact lens targeting residual uncorrected aberration. Moreover, by modifying the pre-manufactured contact lens, only one contact lens may be manufactured in the process, not two. A distinguishing feature of the present disclosure is that the custom contact lens is arrived at by altering an existing, pre-manufactured contact lens (e.g., spherical or sphero-cylindrical contact lens), rather than building the custom lens from scratch.

### Methods of Customizing Pre-Manufactured Contact Lenses

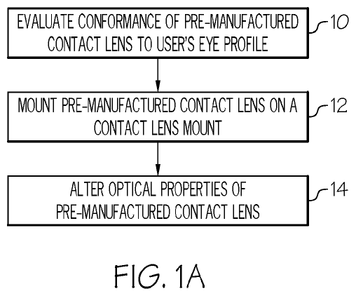

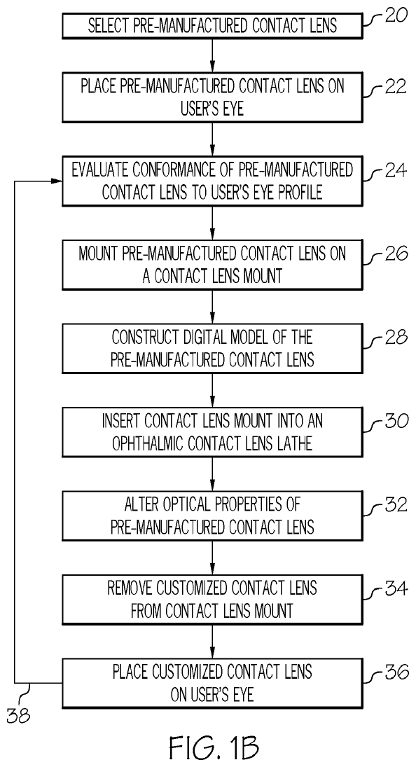

In some embodiments, the present disclosure pertains to methods of customizing a pre-manufactured contact lens for a user. In some embodiments illustrated in FIG. 1A, the methods of the present disclosure include: evaluating the conformance of a pre-manufactured contact lens to the user's eye profile (step 10); and conforming one or more optical properties of the pre-manufactured contact lens or a duplicate thereof to the user's eye profile based on the evaluation. In some embodiments, the conforming includes mounting the pre-manufactured contact lens on a contact lens mount (step 12); and altering the one or more optical properties of the pre-manufactured contact lens on the contact lens mount based on the evaluation (step 14).

As set forth in more detail herein, the methods of the present disclosure can have various embodiments and steps. For instance, in some embodiments illustrated in FIG. 1B, the methods of the present disclosure include one or more steps of: selecting a pre-manufactured contact lens (step 20); placing the pre-manufactured contact lens on a user's eye (step 22); evaluating the conformance of the pre-manufactured contact lens to the user's eye profile (step 24); mounting the pre-manufactured contact lens on a contact lens mount (step 26); constructing a digital model of the pre-manufactured contact lens (step 28); inserting the contact lens mount into an ophthalmic contact lens lathe (step 30); altering one or more optical properties of pre-manufactured contact lens based on the evaluation (step 32); and removing the customized contact lens from the contact lens mount (step 34). In some embodiments, the customized contact lens may then be placed back on the user's eye (step 36) for further evaluation of the conformance of the contact lens to the user's eye profile (step 38). Thereafter, one or more steps of the methods of the present disclosure may be repeated to further customize the premanufactured contact lens.

### Evaluation of the Conformance of Pre-Manufactured Contact Lenses to a User's Eye Profile

The methods of the present disclosure may be utilized to evaluate the conformance of pre-manufactured contact lenses to various eye profiles of a user. For instance, in some embodiments, the eye profile includes one or more eye aberrations. In some embodiments, the eye aberrations include, without limitation, spherical refractive errors, cylindrical refractive errors, residual eye aberrations, higher-order aberrations, or combinations thereof.

The methods of the present disclosure may utilize various processes to evaluate the conformance of pre-manufactured contact lenses to a user's eye profile. For instance, in some embodiments, the evaluation includes placing the pre-manufactured contact lens on the user's eye and evaluating the conformance of the pre-manufactured contact lens to the user's eye profile on the user's eye. In some embodiments, the evaluation includes, without limitation, evaluating the fit of the pre-manufactured contact lens on the user's eye, evaluating the optical properties of the pre-manufactured contact lens on the user's eye, or combinations thereof.

In some embodiments, the evaluation of the conformance of a pre-manufactured contact lens to a user's eye profile includes quantifying one or more eye aberrations of the user's eye profile while the user is wearing the pre-manufactured contact lens. In some embodiments, the quantification includes quantifying the residual optical aberrations of the user's eye while the user is wearing the pre-manufactured contact lens.

Various methods may be utilized to quantify one or more eye aberrations of a user's eye profile while the user is wearing the pre-manufactured contact lens. For instance, in some embodiments, the one or more eye aberrations of the pre-manufactured contact lens on the user's eye are quantified with a wavefront sensor. In some embodiments, the one or more eye aberrations of the pre-manufactured contact lens on the user's eye that are quantified with a wavefront sensor are reported using a mathematical function. In some embodiments, the mathematical function used to report the one or more eye aberrations of the pre-manufactured contact lens on the user's eye that are quantified with a wavefront sensor is the Zernike polynomial.

In some embodiments, the evaluation of the conformance of a pre-manufactured contact lens to a user's eye profile includes constructing a digital model of the pre-manufactured contact lens. In some embodiments, the digital model is constructed while the pre-manufactured contact lens is on the user's eye. In some embodiments, the digital model is constructed after mounting the pre-manufactured contact lens on the contact lens mount. In some embodiments, the digital model is constructed after the pre-manufactured contact lens is removed from the user's eye and placed on a contact lens mount.

In some embodiments, the methods of the present disclosure also include a step of altering the digital model to incorporate a proposed correction for the user's residual eye aberrations. In some embodiments, the proposed correction for the user's residual eye aberrations is determined from the evaluation of the conformance of a pre-manufactured contact lens to a user's eye profile. In some embodiments, the methods of the present disclosure also include integrating the proposed correction into a digital description of a modified anterior or posterior surface of the pre-manufactured contact lens. In some embodiments, the proposed correction defines a modification to the pre-manufactured contact lens.

In some embodiments, the constructed digital model includes a digital model of the surface profile of the pre-manufactured contact lens on the user's eye. In some embodiments, the surface profile of the pre-manufactured contact lens is provided by the manufacturer of the pre-manufactured contact lens. In some embodiments, the surface profile of the pre-manufactured contact lens is identified through objective measurement of the surface, independent of interaction with the manufacturer of the pre-manufactured contact lens.

Various methods may be utilized to construct a digital model of the surface profile of the pre-manufactured contact lens. For instance, in some embodiments, the digital model of the surface profile of the pre-manufactured contact lens is constructed by contact scanning, non-contact scanning, prior knowledge of the surface profile, or combinations thereof. In some embodiments, the digital model is constructed while the pre-manufactured contact lens is mounted on a contact lens mount.

In some embodiments, the digital model of the surface profile of the pre-manufactured contact lens is constructed by contact scanning. In some embodiments, contact scanning occurs by placing a pre-manufactured contact lens into a contact scanning apparatus. The contact scanning apparatus may then systematically touch (or probe) the contact lens surface based on a pre-defined scanning pattern. Each time the contact lens surface is touched, the location in space where that touching occurred is recorded. In some embodiments, the contact scanning can move a probe tip in a controlled fashion in discrete steps in a specific plane. When contact is made for a specific location, a value is recorded. By performing this operation in a systematic fashion in a specific plane, the surface of the contact lens may be recorded, thereby forming a digital model of the contact lens surface. In some embodiments, the digital model is in the form of a three-dimensional digital point cloud that represents the surface of the pre-manufactured contact lens.

In some embodiments, the digital model of the surface profile of the pre-manufactured contact lens is constructed by non-contact scanning. In some embodiments, non-contact scanning occurs by placing a pre-manufactured contact lens into a non-contact scanning apparatus. The non-contact scanning apparatus may then project light onto the contact lens surface. In some embodiments, the light completely illuminates the surface of the contact lens. In other embodiments, the light is only projected onto a small, local area of the contact lens. In both embodiments, the reflected light is collected by the non-contact scanner. The non-contact scanner then processes the reflected light in a manner that allows the surface of the contact lens to be recorded, forming a digital model of the contact lens surface. In some embodiments, the digital model is in the form of a three-dimensional digital point cloud that represents the surface of the pre-manufactured contact lens.

In some embodiments, the coordinate system of a scan (e.g., a contact and/or non-contact scan) is interpolated to the coordinate system of an ophthalmic lens lathe. In some embodiments, the coordinate system of the scan is within a known tolerance of the actual surface profile of the pre-manufactured contact lens.

In some embodiments, the model is constructed through the utilization of a software or algorithm. In some embodiments, the software or algorithm digitally describes the manner in which modification of the pre-manufactured contact lens surface is to be achieved.

In some embodiments, the digital model of the surface profile of the pre-manufactured contact lens is constructed by an algorithm that receives scanned surface data and transforms the data into a format that is processable by an ophthalmic contact lens lathe. Various algorithms may be utilized to construct a digital model of a surface profile of a contact lens. For instance, in some embodiments, the algorithm is operational to smooth out noisy data resulting from a scanning process. In some embodiments, the algorithm includes a mathematical function that is fitted. In some embodiments, the algorithm utilizes the fitted mathematical function to generate data sets from a scanning process.

In some embodiments where a mathematical function is not fitted in an algorithm, the algorithm may generate a dataset directly from the scanned data. For instance, in some embodiments, the algorithm evaluates scanned data (e.g., through interpolation and/or calculation) at specific, predetermined points that correspond to a required sampling density necessary to implement a desired correction profile on an optical lens lathe, thereby forming a new dataset. In some embodiments, the new dataset may be stored (along with any requisite header information) in a computer file that can be interpreted by an optical lens lathe. When interpreted and executed by an optical lens lathe, the computer file can result in the modification of the surface of the pre-manufactured contact lens by the contact lens lathe.

### Mounting Contact Lenses on a Contact Lens Mount

Various methods may be utilized to conform one or more optical properties of a pre-manufactured contact lens or a duplicate thereof to a user's eye profile. For instance, in some embodiments, the conformation step includes mounting a pre-manufactured contact lens on a contact lens mount and altering one or more optical properties of the pre-manufactured contact lens on the contact lens mount. In some embodiments, the contact lens mount holds the pre-manufactured contact lens in a known position relative to cutting surfaces of an ophthalmic contact lens lathe.

The methods of the present disclosure may utilize various contact lens mounts. For instance, in some embodiments, the contact lens mount holds the pre-manufactured contact lens in a known position relative to cutting surfaces of an ophthalmic contact lens lathe.

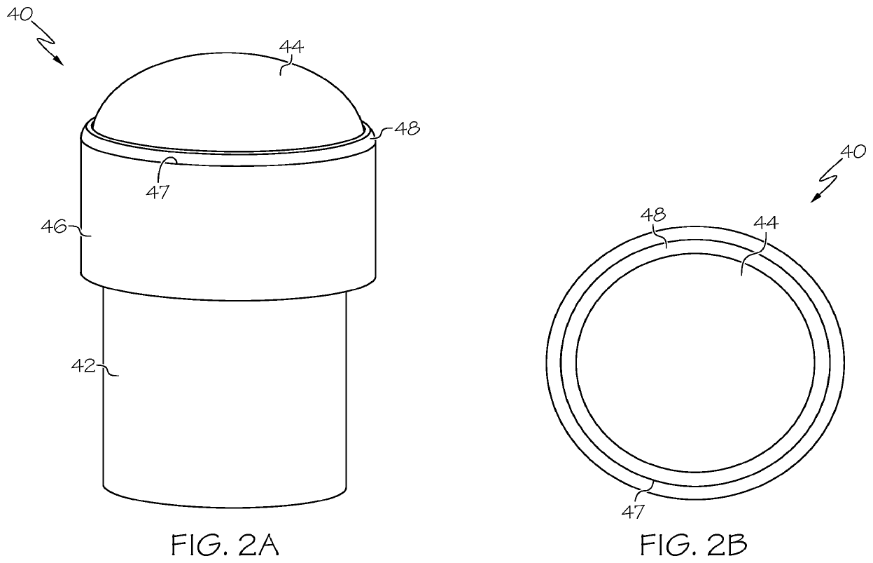

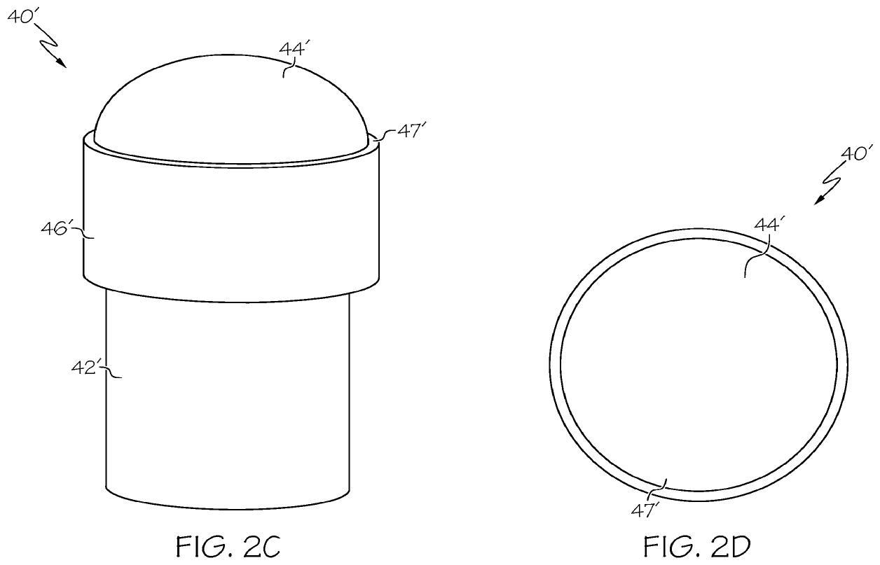

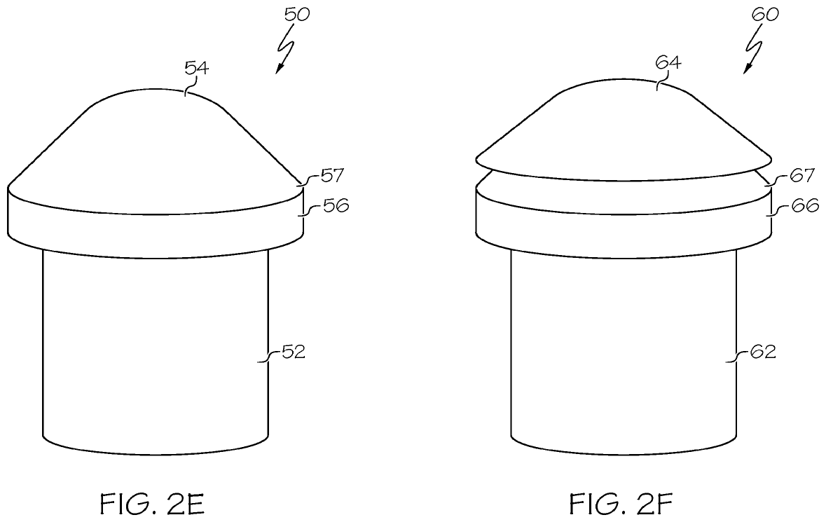

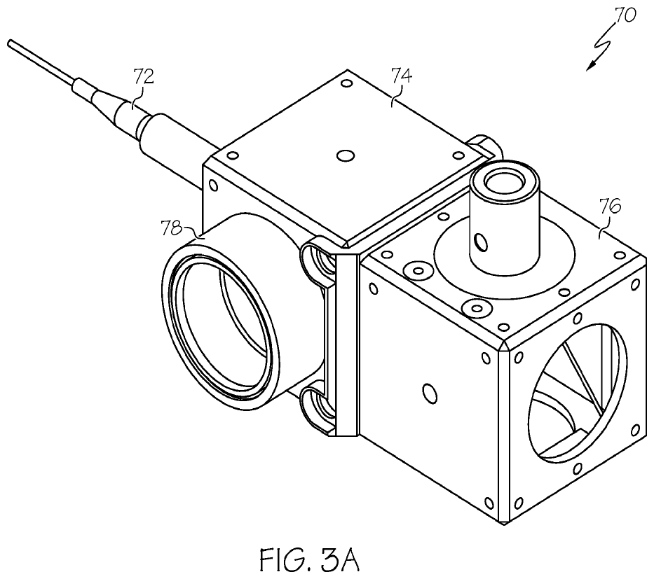

In some embodiments, the contact lens mount includes a convex contact lens mount. An example of a convex contact lens mount is shown as contact lens mount 40 in FIGS. 2A and 2B for illustrative purposes. Convex contact lens mount 40 may include a base area 42 that is operational for anchoring the contact lens mount. Convex contact lens mount 40 may also include a convex surface 44 that is operational to mount a pre-manufactured contact lens.

In some embodiments, base area 42 is in the form of a cylindrical shaft. In some embodiments, base area 42 is operational to be insertable into a contact lens lathe.

In some embodiments, convex contact lens mount 40 also includes a protruded area 46 that is positioned between the base area 42 and the convex surface 44. In some embodiments, the protruded area 46 includes a protruded edge 47 that surrounds the convex surface 44.

In some embodiments, the protruded area 46 is in the form of a cylindrical shaft. In some embodiments, the protruded area 46 has a diameter that is larger than the diameter of the base area 42. In some embodiments, the protruded area 46 has the same diameter as the convex surface 44.

In some embodiments, convex contact lens mount 40 also includes a layer 48 that is positioned on the protruded edge 47. In some embodiments, layer 48 is operational to facilitate the mounting of the pre-manufactured contact lens on the convex surface 44. In some embodiments, convex surface 44 has a curvature that matches a curvature of a pre-manufactured contact lens (e.g., a hydrated (wet) soft contact lens). In some embodiments, layer 48 is operational to facilitate the mounting of the pre-manufactured contact lens on the convex surface 44 by increasing the friction between the pre-manufactured contact lens and the convex surface. In some embodiments, layer 48 is in the form of a ring, such as an O-ring.

The convex contact lens mounts of the present disclosure may include numerous structures and variations. For instance, an example of an alternative contact lens mount is shown as contact lens mount 40′ in FIGS. 2C and 2D for illustrative purposes. In this example, convex contact lens mount 40′ includes a base area 42′ that is operational for anchoring the contact lens mount, a convex surface 44′ that is operational to mount a pre-manufactured contact lens, and a protruded area 46′ that is positioned between the base area 42′ and the convex surface 44′. In this embodiment, convex surface 44′ also has a curvature that matches a curvature of a pre-manufactured contact lens (e.g., a hydrated (wet) soft contact lens). In this embodiment, protruded area 46′ includes a protruded edge 47′ that surrounds the convex surface 44′. However, in this embodiment, convex contact lens mount 40′ docs not include a layer that is positioned on the protruded edge 47′.

Another alternative contact lens mount is shown as contact lens mount 50 in FIG. 2E for illustrative purposes. In this example, convex contact lens mount 50 includes a base area 52 that is operational for anchoring the contact lens mount, a convex surface 54 that is operational to mount a pre-manufactured contact lens, and a protruded area 56 that is positioned between the base area 52 and the convex surface 54. Protruded area 56 includes a protruded edge 57 that surrounds the convex surface 54.

Another alternative contact lens mount is shown as contact lens mount 60 in FIG. 2F for illustrative purposes. In this example, convex contact lens mount 60 includes a base area 62 that is operational for anchoring the contact lens mount, a convex surface 64 that is operational to mount a pre-manufactured contact lens, and a protruded area 66 that is positioned between the base area 62 and the convex surface 64. Protruded area 66 includes a protruded edge 67 that surrounds the convex surface 64.

In some embodiments, the methods of the present disclosure also include a step of aligning a pre-manufactured contact lens on a convex contact lens mount. In some embodiments, an external device may be utilized to facilitate the alignment. In some embodiments, the external device includes, without limitation, an interferometer, a camera, a position sensor, a quad cell, a multi-element detector, an external device that is operational to align the contact lens and the lens mount, or combinations thereof.

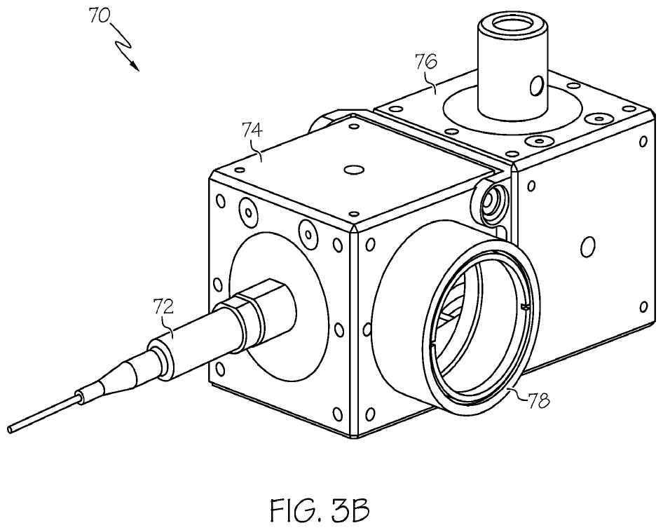

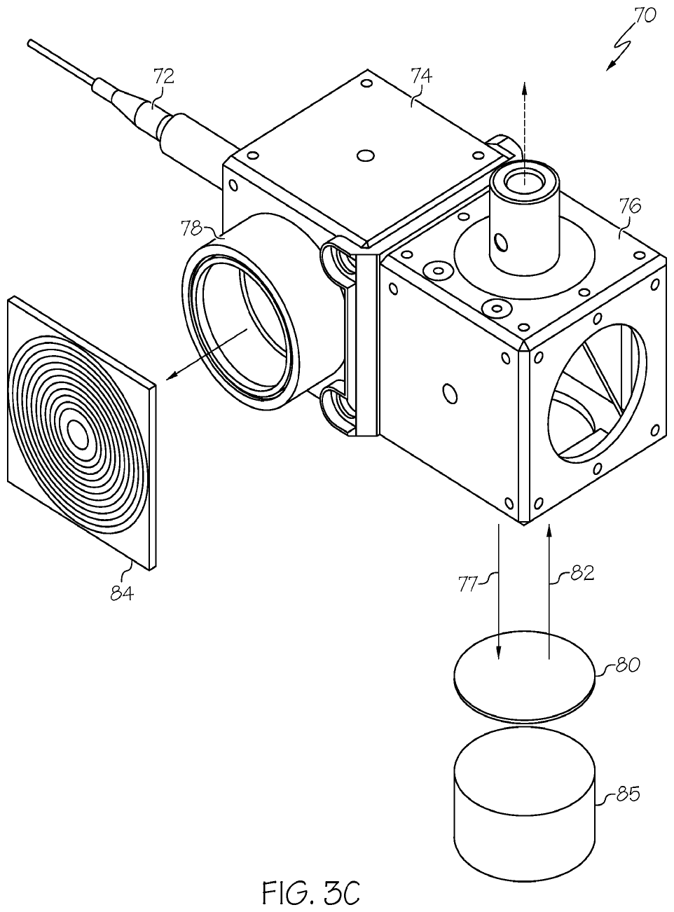

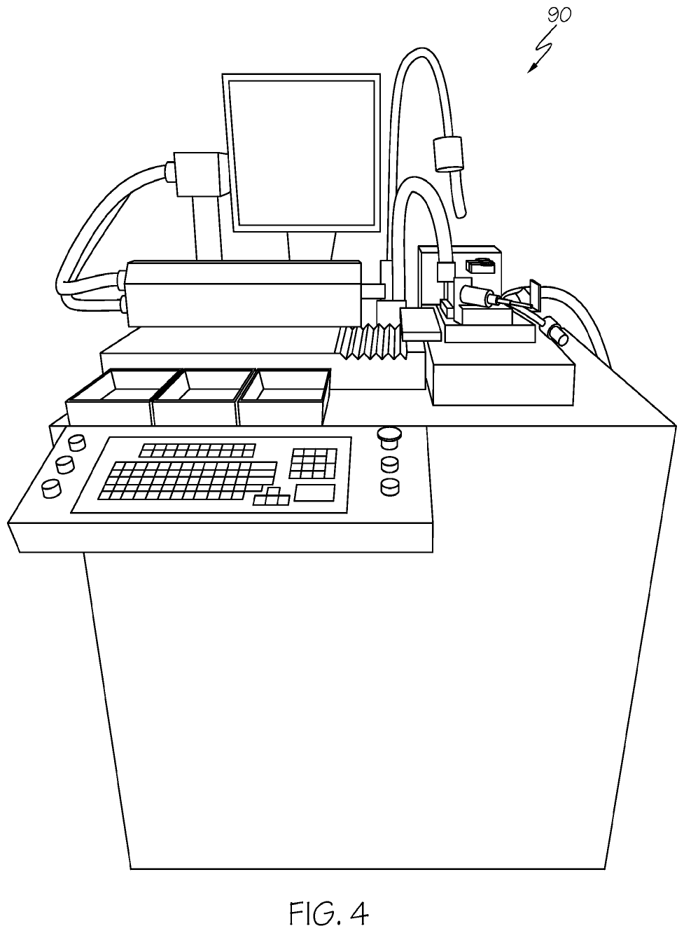

In some embodiments, the alignment occurs by interferometry. An example of an interferometer that can be used for aligning a premanufactured contact lens is shown in FIGS. 3A-3C as interferometer 70 for illustrative purposes. In some embodiments, interferometer 70 includes a laser source 72, a beam splitting optical assembly 74, a prism optical assembly 76, and a projection lens optical assembly 78.

In some embodiments, laser source 72 is fiber coupled. In some embodiments, laser source 72 is battery powered. In some embodiments, laser source 72 is self-contained within the interferometer 70. In preferred embodiments, laser source 72 is monochromatic (i.e., contains a single pure wavelength) in order to produce interference fringes.

In operation, interferometer 70 is positioned relative to a contact lens mount 85 such that it is mechanically aligned to the axis of rotation or “center” of contact lens mount 85. Beam splitting optical assembly 74 divides the laser beam path such that half of the beam is directed toward prism optical assembly 76, which bends the beam path at a 90-degree (most conveniently downward) angle to align it with the mechanical axis of contact lens mount 85. A contact lens 80 may be held within beam path 77 from prism optical assembly 76 with a convex contact lens mount 85. The convex contact lens mount 85 allows a practitioner to translate the contact lens 80 within a horizontal plane and rotate the lens about all axes. Laser light that is partially reflected from the front and back surfaces of the contact lens produce two new beams 82 that travel back up toward interferometer 70. The beams 82 then travel back through the interferometer 70 toward beam splitting optical assembly 74. When contact lens 80 is closely aligned to the mechanical axis of the convex contact lens mount 85, beams 82 will interfere with one another and produce fringes or “rings”. The fringes are viewed via a projection lens optical assembly, which forms an image of the fringes on a screen 84. Exact lens alignment is achieved when the “rings” of the fringe pattern become perfectly concentric, as obtained using a adjustments on the convex contact lens mount 85 to translate and rotate the lens in fine increments.

The methods of the present disclosure may also utilize various methods to mount a contact lens on a contact lens mount. For instance, in some embodiments (e.g., embodiments where the pre-manufactured contact lens is a soft contact lens), the mounting includes dehydrating the pre-manufactured contact lens onto the contact lens mount. In some embodiments (e.g., embodiments where the pre-manufactured contact lens is a soft contact lens), the mounting includes freezing a soft contact lens to the contact lens mount. In some embodiments (e.g., embodiments where the pre-manufactured contact lens is a rigid contact lens), the mounting includes waxing a surface of the contact lens mount. In some embodiments (e.g., embodiments where the pre-manufactured contact lens is a rigid contact lens), the mounting includes using a vacuum to adhere the contact lens to the contact lens mount.

### Altering the Properties of a Contact Lens

Various methods may also be utilized to alter one or more optical properties of a pre-manufactured contact lens. For instance, in some embodiments, the altering includes removing material from the pre-manufactured contact lens. In some embodiments, the removal includes removing a layer from the pre-manufactured contact lens surface. In some embodiments, the removal includes removing a layer of less than 10 microns in thickness from the pre-manufactured contact lens surface.

In some embodiments, the altering of one or more optical properties of a pre-manufactured contact lens includes the steps of inserting a contact lens mount that includes a pre-manufactured contact lens into an ophthalmic contact lens lathe and utilizing the ophthalmic contact lens lathe to alter one or more optical properties of the pre-manufactured contact lens.

The methods of the present disclosure may utilize various types of ophthalmic contact lens lathes to alter one or more properties of a pre-manufactured contact lens. An example of an ophthalmic contact lens lathe is shown in FIG. 4 as ophthalmic contact lens lathe 90 for illustrative purposes. Ophthalmic contact lens lathes have been used historically to first carve a concave surface into one flat face of a contact lens button. The concave surface forms the posterior surface of the contact lens (i.e., the portion that touches the patient's eye). The newly cut concave surface is then attached to a contact lens mount using a thin layer of wax. The lens mount/contact lens button is then placed into the ophthalmic contact lens lathe, and a convex surface is carved onto the remaining second flat face of the contact lens button, forming the contact lens.

In the embodiments of the present disclosure, a pre-manufactured contact lens may be mounted onto a contact lens mount through one of the methods described herein. Once mounted, the contact lens and the contact lens mount may be inserted into the ophthalmic contact lens lathe. Thereafter, a small amount of contact lens material may be removed from the front surface of the pre-manufactured contact lens. The cut pattern resulting in the small amount of plastic being removed may be designed to correct for one or more eye aberrations (e.g., eye aberrations measured when a patient was wearing the pre-manufactured contact lens or an exact duplicate thereof). In some embodiments, the cut pattern may be designed from subjective methods (e.g., subjective refraction) or objective methods (e.g., wavefront sensing, corneal topography, autorefraction or any method than objectively determines the refractive state of the eye or lens/eye combination). In some embodiments, the cut pattern may determine the intended optical correction. In some embodiments, the intended optical correction may be added to the scanned surface of the pre-manufactured contact lens.

Removal of Contact Lens from Contact Lens Mount

In some embodiments, the methods of the present disclosure may also include a step of removing an altered contact lens from a contact lens mount (referred to thereafter as a customized contact lens). Various methods may be utilized to remove a customized contact lens mount from a surface. For instance, in some embodiments, the removal occurs by rehydrating a dehydrated contact lens, thereby releasing the lens from the mount surface. In some embodiments, the removal occurs by detaching the customized contact lens from the contact lens mount. In some embodiments, the detaching includes increasing the temperature of a soft contact lens attached to the contact lens mount. In some embodiments, the detaching includes removing or reducing the vacuum that is adhering the contact lens to the contact lens mount. In some embodiments, the detaching includes removing the wax layer adhering the contact lens to the contact lens mount.

### Pre-Manufactured Contact Lenses

The methods of the present disclosure may be utilized to customize various pre-manufactured contact lenses. For instance, in some embodiments, the pre-manufactured contact lens is a soft contact lens. In some embodiments, the pre-manufactured contact lens is a rigid contact lens. In some embodiments, the rigid contact lens is a scleral lens. In some embodiments, the rigid contact lens is a corneal lens.

In some embodiments, the methods of the present disclosure also include a step of selecting a pre-manufactured contact lens to be conformed. In some embodiments, the selection is based on one or more criteria. In some embodiments, the one or more criteria includes, without limitation, user fitness, user comfort, diopter value, current methods of clinical practice well-known in the field, or combinations thereof.

### Aberration Correction

In some embodiments, the methods of the present disclosure create a customized contact lens that provides a user with aberration correction. In some embodiments, the aberration correction is provided by the customized contact lens, which is itself a modification of the pre-manufactured contact lens rather than through iterative production of a second contact lens that mimics the characteristics of the pre-manufactured contact lens. In some embodiments, the aberration correction includes, without limitation, sphere aberration correction, cylinder aberration correction, higher-order aberration correction, Zernike aberration correction, and combinations thereof.

### Systems for Customizing Contact Lenses

Additional embodiments of the present disclosure pertain to systems for customizing a contact lens (e.g., a pre-manufactured contact lens). In some embodiments, the systems of the present disclosure include a convex contact lens mount. In some embodiments, the convex contact lens mount includes a base area operational for anchoring the convex contact lens mount, and a convex surface operational to mount the contact lens. In some embodiments, the base area is in the form of a cylindrical shaft. In some embodiments, the base area is insertable into a contact lens lathe.

In some embodiments, the convex contact lens mount also includes a protruded area positioned between the base area and the convex surface. In some embodiments, the protruded area includes a protruded edge that surrounds the convex surface. In some embodiments, the protruded area is in the form of a cylindrical shaft. In some embodiments, the protruded area has a diameter larger than the diameter of the base area. In some embodiments, the protruded area has the same diameter as the convex surface.

In some embodiments, the convex contact lens mount also includes a layer positioned on the protruded edge. In some embodiments, the layer is operational to facilitate the mounting of the contact lens on the convex surface. In some embodiments, the layer is in the form of a ring.

The convex contact lens mounts of the present disclosure can have various structures and arrangements. Examples of suitable convex contact lens mounts were described supra with reference to FIGS. 2A-2F. For instance, an example of a convex contact lens mount is shown as convex contact lens mount 40 in FIGS. 2A and 2B. Convex contact lens mount 40 may include a base area 42 that is in the form of a cylindrical shaft and operational for anchoring the contact lens mount, a convex surface 44 that is operational to mount a contact lens, and a protruded area 46 that is positioned between the base area 42 and the convex surface 44.

Protruded area 46 is in the form of a cylindrical shaft with a diameter that is larger than the diameter of the base area 42. Additionally protruded area 46 has the same diameter as the convex surface 44. In some embodiments, convex surface 44 has a curvature that matches a curvature of a contact lens (e.g., hydrated (wet) soft contact lens).

Protruded area 46 also includes a protruded edge 47 that surrounds the convex surface 44. Additionally, convex contact lens mount 40 includes a layer 48 that is positioned on the protruded edge 47. Layer 48 is in the form of a ring, such as an O-ring.

An alternative contact lens mount is shown as contact lens mount 40′ in FIGS. 2C and 2D. In this example, convex contact lens mount 40′ includes a base area 42′ that is operational for anchoring the contact lens mount, a convex surface 44′ that is operational to mount a contact lens, and a protruded area 46′ that is positioned between the base area 42′ and the convex surface 44′. In this embodiment, protruded area 46′ includes a protruded edge 47′ that surrounds the convex surface 44′. In some embodiments, convex surface 44′ has a curvature that matches a curvature of a contact lens (e.g., hydrated (wet) soft contact lens). However, in this embodiment, convex contact lens mount 40′ does not include a layer that is positioned on the protruded edge 47′.

In some embodiments, the systems of the present disclosure also include an interferometer. In some embodiments, the interferometer is operational to align the contact lens on the convex contact lens mount by interferometry.

In some embodiments, the systems of the present disclosure also includes an algorithm that is operable to construct a digital model of the contact lens on the convex contact lens mount. In some embodiments, the algorithm includes programming instructions for altering the digital model to incorporate a proposed correction for a user's residual eye aberrations and integrating the proposed correction into a digital description of the modified anterior or posterior surface of the contact lens. In some embodiments, the digital model of the surface profile of the pre-manufactured contact lens is constructed by contact scanning, non-contact scanning, prior knowledge of the surface profile, or combinations thereof. In some embodiments, the algorithm includes programming instructions for receiving scanned surface data and transforming the data into a format that is processable by an ophthalmic contact lens lathe.

In some embodiments, the systems of the present disclosure also include an ophthalmic contact lens lathe. In some embodiments, the ophthalmic contact lens lathe is in electrical communication with the algorithm. In some embodiments, the ophthalmic contact lens lathe is operable to receive scanned and transformed surface data from the algorithm and alter one or more optical properties of the contact lens on the convex contact lens mount. In some embodiments, the contact lens that has been attached to the convex contact lens mount is insertable into the ophthalmic contact lens lathe. In some embodiments, the contact lens is mounted on the convex contact lens mount. In some embodiments, the contact lens is in dehydrated form.

### Pre-Manufactured Contact Lenses

In some embodiments, the present disclosure pertains to a customized contact lens that represents a modified version of a pre-manufactured contact lens. In some embodiments, the customized contact lens is modified by conforming one or more optical properties of a pre-manufactured contact lens to a user's eye profile. In some embodiments, the customized contact lens is prepared in accordance with the methods of the present disclosure.

In some embodiments, the customized contact lens includes a surface. In some embodiments, the surface includes a removed material from the pre-manufactured contact lens. In some embodiments, the removed material includes a layer. In some embodiments, the removed layer includes a layer of less than 10 microns in thickness.

In some embodiments, the pre-manufactured contact lens is a soft contact lens. In some embodiments, the pre-manufactured contact lens is a rigid contact lens. In some embodiments, the rigid contact lens is a scleral lens. In some embodiments, the rigid contact lens is a corneal lens.

In some embodiments, the customized contact lens is a physical derivative of a pre-manufactured contact lens and is not a newly manufactured customized contact lens. In some embodiments, the pre-manufactured contact lens is one that is manufactured by other contact lens manufacturers and not necessarily manufactured by the manufacturer applying/implementing the customization. In some embodiments, the custom contact lens is imparted onto the pre-manufactured contact lens, and is the pre-manufactured contact lens, except those modifications required to implement the customization that corrects the residual optical aberrations.

### Methods for Modifying Pre-Manufactured Contact Lenses.

In additional embodiments, the present disclosure pertains to dehydration-based methods of modifying a pre-manufactured contact lens. In some embodiments, such methods include: placing the pre-manufactured contact lens on a contact lens mount; and dehydrating the pre-manufactured contact lens on the contact lens mount.

In some embodiments, the methods of the present disclosure also include a step of removing the pre-manufactured contact lens from the contact lens mount. In some embodiments, the removal occurs by rehydrating the dehydrated contact lens. In some embodiments, the modification includes customizing the pre-manufactured contact lens for a user in accordance with the pre-manufactured contact lens customization methods of the present disclosure.

In additional embodiments, the present disclosure pertains to vacuum-based methods of attaching a pre-manufactured contact lens to a contact lens mount. In some embodiments, such methods include: placing the pre-manufactured contact lens on a contact lens mount; and adhering the contact lens to the mount via a vacuum. In some embodiments, vacuum is used to hold and position the contact lens in an aligned fashion prior to attaching it to a contact lens mount. In some embodiments, the adhesion also includes waxing a surface of the contact lens mount.

In some embodiments, the methods of the present disclosure also include a step of removing the pre-manufactured contact lens from the contact lens mount. In some embodiments, the removal occurs by removing the vacuum that is causing the contact lens to adhere to the mount.

In additional embodiments, the present disclosure pertains to freezing a pre-manufactured soft contact lens to a contact lens mount. In some embodiments, such methods include: placing the pre-manufactured soft contact lens on a contact lens mount; and adhering the contact lens to the mount via freezing the contact lens. In some embodiments, the methods of the present disclosure also include a step of removing the soft contact lens from the contact lens mount. In some embodiments, the removal occurs by increasing the temperature of the soft contact lens.

### Applications and Advantages

The present disclosure provides numerous advantages and applications. For instance, in some embodiments, the customized contact lenses that have been customized in accordance with the methods of the present disclosure provide the user with aberration correction. In some embodiments, the aberration correction is provided by the conformed contact lens rather than through iterative production of a second contact lens that integrates the characteristics of the pre-manufactured contact lens and the residual aberrations measured through the pre-manufactured contact lens into the second contact lens. In some embodiments, the aberration correction includes, without limitation, sphere aberration correction, cylinder aberration correction, higher-order aberration correction, and combinations thereof. In some embodiments, the manufacturer implementing the alterations to the pre-manufactured lens is the same as manufacturer of the pre-manufactured lens. In some embodiments, the manufacturer implementing the alterations to the pre-manufactured lens is not the same as manufacturer of the pre-manufactured lens.

In some embodiments, the present disclosure provides a novel method of soft and rigid contact lens modification that would allow for the optical signature of an existing (e.g., pre-manufactured) soft or rigid contact lens to be altered after production, targeting the individualized level of sphere, cylinder, and higher-order aberration correction. In some embodiments, such methods could allow the final contact lens to leverage successfully fit pre-manufactured soft contact lenses and pre-manufactured rigid contact lenses and the significant efforts that went into making that contact lens commercially successful (e.g., on-eye stability, comfort, and low cost), while tailoring the optical correction to an individual (e.g., for an additional cost). Accordingly, numerous embodiments of the present disclosure provide a personalized optical correction and system for commercially available contact lenses, which would allow any contact lens available on the market today to become a customized contact lens that meets the individual optical needs of the eye wearing it.

In some embodiments, if the patient is already wearing a contact lens and desires an improved correction that includes the correction of residual errors, a second identical contact lens can be ordered and modified to include the additional aberrations to allow the patient functionality while the contact lens is being made. However, in various embodiments, the methods of the present disclosure pertain to a single contact lens process, as the modification to include the residual aberration correction is imparted onto a pre-manufactured contact lens or an exact duplicate thereof. In some embodiments, the methods of the present disclosure do not require the residual aberration correction be integrated into the design of the pre-manufactured contact lens and a second contact lens produced. Instead, the residual aberration correction is imparted directly onto the pre-manufactured contact lens in a manufacture process, resulting in a modification to the pre-manufactured contact lens itself, rather than the manufacture of a second contact lens that contains the residual aberration correction in the design of the lens.

Reference will now be made to more specific embodiments of the present disclosure and experimental results that provide support for such embodiments. However, Applicant notes that the disclosure herein is for illustrative purposes only and is not intended to limit the scope of the claimed subject matter in any way.

### Additional Embodiments

### Example 1. Optical Properties (Zernike Terms) for Custom Contact Lenses

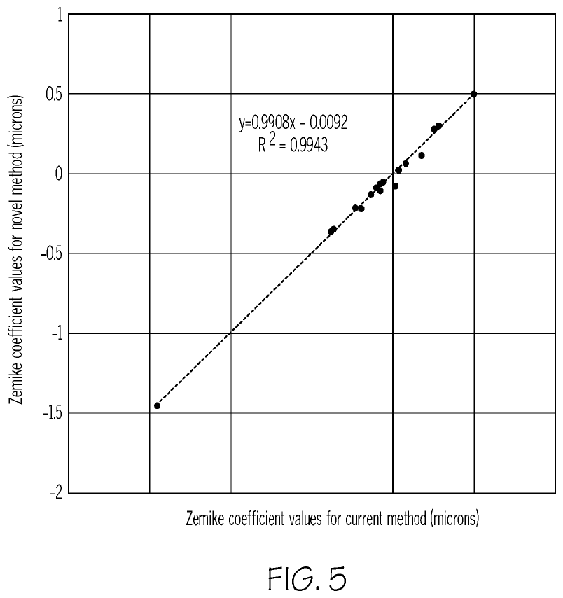

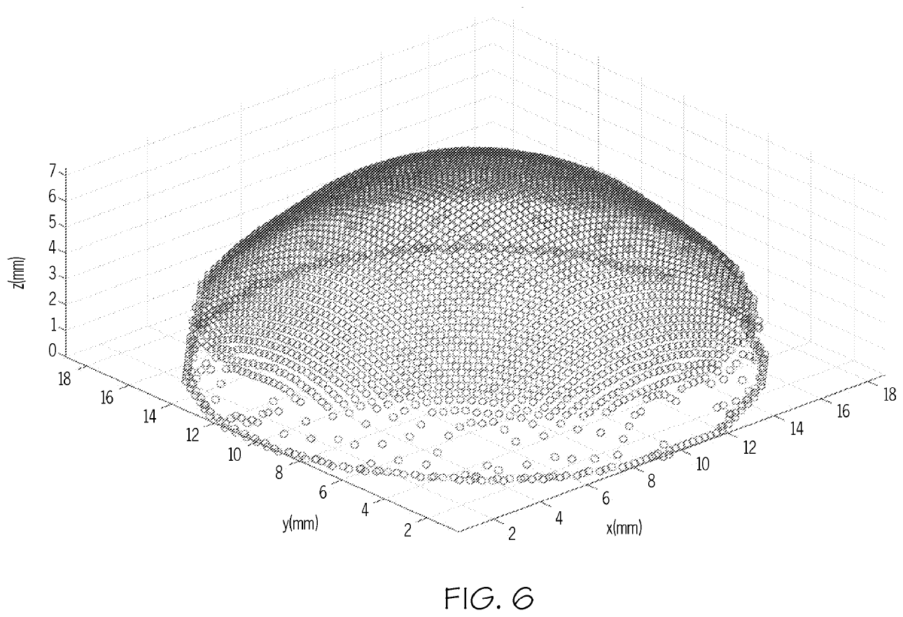

This Example provides a demonstration in practice of methods of customizing pre-manufactured contact lenses in accordance with the methods of the present disclosure for a rigid scleral contact lens. The methods described in this Application have been demonstrated in the laboratory, as described below and summarized in FIG. 5.

The inventors manufactured a custom contact lens in a fashion that is consistent with the current state of the art, which requires the manufacture of a spherical lens and a subsequent custom lens. The inventors then manufactured a second custom lens using a subset of the techniques described above. In brief, manufacture of the custom lens using the current state of the art included the following steps: 1) A subject wore a spherical contact lens of known design. 2) The residual aberrations of the spherical lens/eye combination were measured while a patient wore the spherical lens of known design. 3) The residual aberrations were integrated into the design of the spherical contact lens in software, resulting in a custom contact lens design. 4) The custom contact lens was manufactured on a contact lens lathe.

In brief, manufacture of a custom lens using the method described by the claims in this patent included the following steps. 1) A subject wore a spherical contact lens of known design. 2) The residual aberrations of the spherical lens/eye combination were measured while a patient wore the spherical lens of known design. 3) The residual aberrations were integrated into the design of the spherical contact lens in software, resulting in a custom contact lens design. 4) The central 14 mm portion of the custom lens design was extracted from the overall custom lens design. 5) A duplicate of the spherical lens of known design was manufactured on a contact lens lathe. 5) Immediately following manufacture of the spherical lens, without removing the spherical contact lens of known design from the arbor, the spherical lens was modified on the contact lens lathe to incorporate the residual aberration correction from step 4). Comparison of the optics imparted in the two lenses was accomplished by optical metrology, whereby the Zernike coefficients for the 2^{nd}-5^{th} radial orders describing the optical properties of each custom lenses were measured.

The graph in FIG. 5 shows that the optical characteristic of the two custom lenses (one manufactured using the current state of the art and one manufactured using the methods described herein). The results indicate that the contact lenses are equivalent. The scatter plot shows Zernike coefficients in the 2-5 order (old method plotted on the x axis, novel method on Y axis). The slope of a linear fit to these data is 0.994 (ideal slope=1.000) and the R² values is 0.994.

### Example 2. Construction of a Digital Model of a Surface Profile of a Contact Lens

This Example describes the construction of a digital model of a surface profile of a contact lens in accordance with various embodiments of the present disclosure. As illustrated in FIG. 6, a contact or non-contact scanner can be used to scan the front surface of the contact lens and form a 3-dimensional digital point cloud that represents the surface of the contact lens. The scanner provided a text file containing the x, y, and z coordinates of data points. FIG. 6 represents a three-dimensional representation of the original scan.

Since an ophthalmic lens lathe may not be able to read the coordinate system of the original scan, the scan file was converted to the coordinate system of the ophthalmic lens lathe. A custom software application (from here on referred to as the “App”) was developed to convert the text file derived from the scanner to a file format (referred to internally as a VOI file) that is compatible with the coordinate system of the ophthalmic lens lathe.

A snapshot of a graphical user interface of the App is shown in FIG. 8. In particular, FIG. 8 shows the design view of the App. There are 10 editable fields that allow the user to enter the lens characteristic. Moreover, there are 2 buttons: (1) “Select scan file”; and (2) “Convert to VOI file”. The first button allows the user to select the scan file. By clicking on the second button, the App will convert the scan file to the file format which has the coordinate system of the ophthalmic lens lathe.

As illustrated in FIG. 8, the App obtains a text file derived from the scanner as an input. A user needs to enter the contact lens diameter, number of angular samples, and number of radial samples. These three parameters are used to calculate the sampling density necessary to implement the desired correction profile on the ophthalmic lens lathe. A user then enters contact lens characteristics including contact lens type (rigid or soft), brand, material, index of refraction, and spherocylindrical power. These contact lens characteristics are descriptive information that will appear as a header in an output file. By clicking on the “Convert to VOI file” button, the App interpolates the dataset at specific points corresponding to the required sampling density necessary to implement the desired correction profile on the ophthalmic lens lathe, thereby forming a new dataset. The new data set will be stored (along with any requisite header information) in a computer file that can be interpreted by the ophthalmic lens lathe.

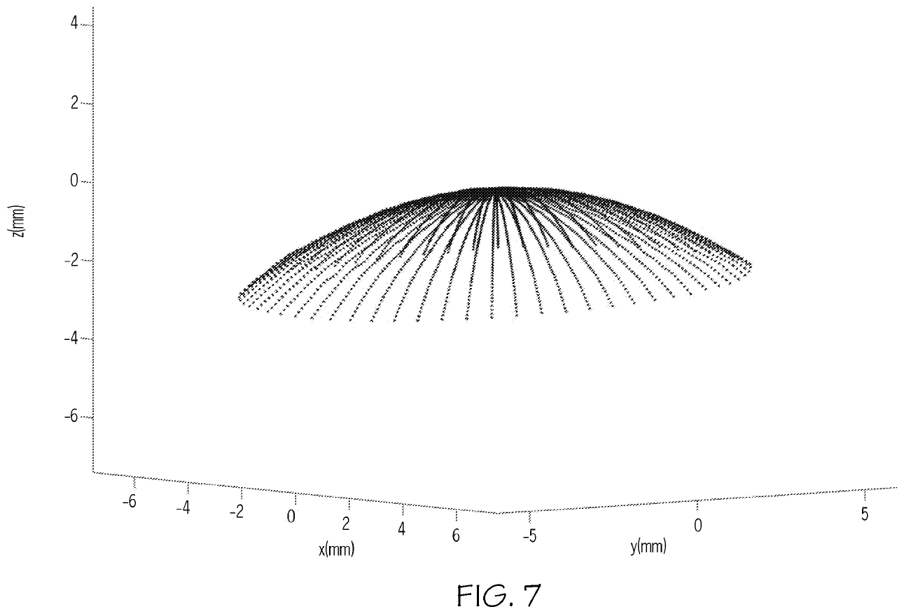

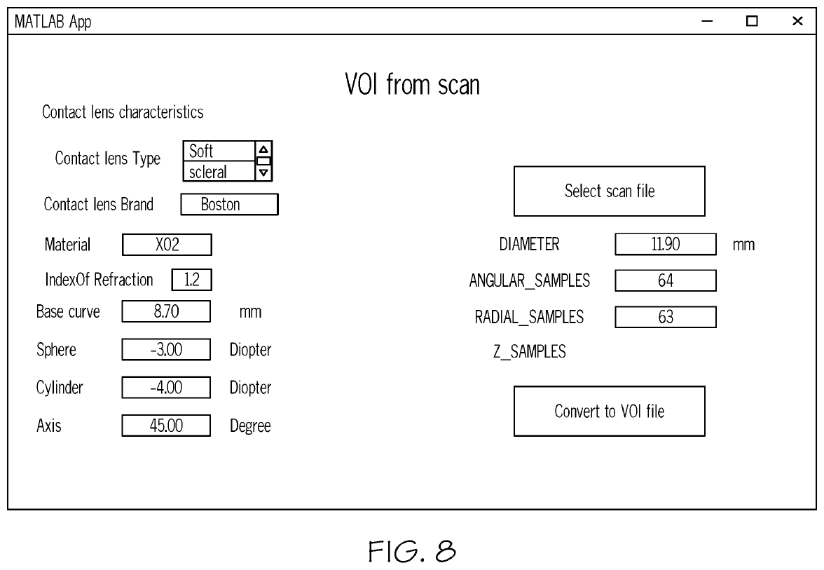

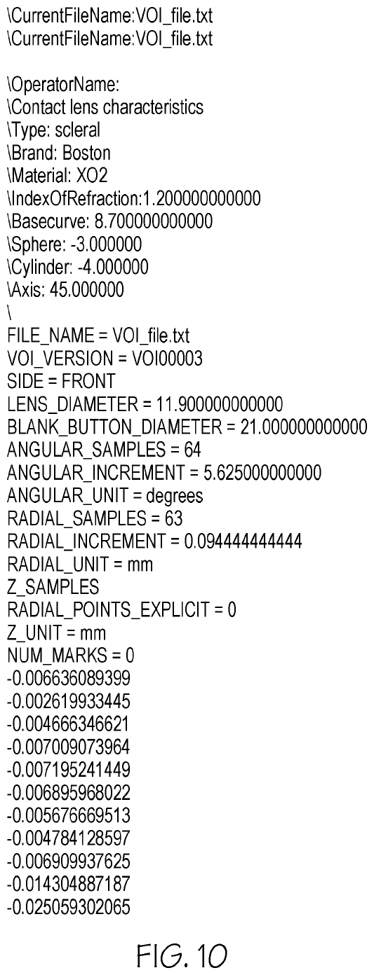

As illustrated in FIG. 7, the App can reconstruct the three-dimensional representation of the contact lens based on the x, y, and z coordinates of data points measured by the scanner. In particular, the App can construct a three-dimensional representation of the contact lens based on the new data set obtained by interpolation. FIG. 7 and the associated VOI file (FIG. 10) have the sampling density necessary to implement the desired correction profile on the ophthalmic lens lathe.

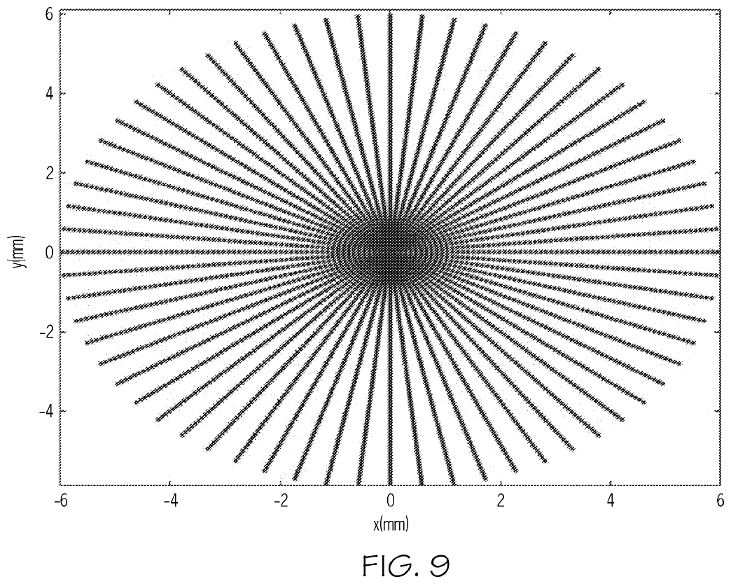

As illustrated in FIG. 9, the App generates a two-dimensional sampling grid of the contact lens using the three parameters (lens diameter, number of angular samples, and number of radial samples) entered by a user. This grid shows the x and y coordinates of the data points where one would desire to obtain a new z value using interpolation. This file (when interpreted and executed by the ophthalmic lens lathe) can also result in the modification of the surface of the pre-manufactured contact lens by the contact lens lathe.

In sum, the App produces an output file containing a new dataset (single column of new Z values in mm) along with any requisite header information to be interpreted by the ophthalmic lens lathe. This file is interpreted and executed by the ophthalmic lens lathe, subsequently resulting in the modification of the surface profile of a pre-manufactured contact lens by the contact lens lathe.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above but is only limited by the claims, including all equivalents of the subject matter of the claims. The disclosures of all patents, patent applications, and publications cited herein are hereby incorporated herein by reference to the extent that they provide procedural or other details consistent with and supplementary to those set forth herein.

1. A method of customizing a pre-manufactured contact lens for a user, wherein the method comprises:
evaluating the conformance of the pre-manufactured contact lens to the user's eye profile;
conforming one or more optical properties of the pre-manufactured contact lens or a duplicate thereof to the user's eye profile based on the evaluation, wherein the conforming comprises:
mounting the pre-manufactured contact lens on a contact lens mount, and
altering one or more optical properties of the pre-manufactured contact lens on the contact lens mount based on the evaluation.

2. The method of claim 1, wherein the eye profile comprises one or more eye aberrations, wherein the one or more eye aberrations comprise spherical refractive errors, cylindrical refractive errors, residual eye aberrations, higher-order aberrations, or combinations thereof.

3. The method of claim 1, wherein the evaluating comprises placing the pre-manufactured contact lens on the user's eye and evaluating the conformance of the pre-manufactured contact lens to the user's eye profile on the user's eye.

4. The method of claim 1, wherein the evaluating comprises quantifying one or more eye aberrations of the user's eye profile while the user is wearing the pre-manufactured contact lens.

5. The method of claim 1, wherein the evaluating comprises constructing a digital model of the pre-manufactured contact lens.

6. The method of claim 5, wherein the digital model is constructed after mounting the pre-manufactured contact lens on the contact lens mount.

7. The method of claim 5, further comprising a step of altering the digital model to incorporate a proposed correction for the user's residual eye aberrations and integrating the proposed correction into a digital description of the modified anterior or posterior surface of the pre-manufactured contact lens.

8. The method of claim 5, wherein the digital model of the surface profile of the pre-manufactured contact lens is constructed by contact scanning, non-contact scanning, prior knowledge of the surface profile, or combinations thereof.

9. The method of claim 5, wherein the digital model of the surface profile of the pre-manufactured contact lens is constructed by an algorithm that receives scanned surface data and transforms the data into a format that is processable by an ophthalmic contact lens lathe.

10. The method of claim 1, wherein the contact lens mount comprises a convex contact lens mount comprising:
a base area operational for anchoring the contact lens mount; and
a convex surface operational to mount the pre-manufactured contact lens, wherein the convex surface comprises a curvature that matches a curvature of the pre-manufactured contact lens.

11. The method of claim 10, wherein the convex contact lens mount further comprises a protruded area positioned between the base area and the convex surface, wherein the protruded area comprises a protruded edge that surrounds the convex surface.

12. The method of claim 11, wherein the protruded area has a diameter larger than the diameter of the base area, and wherein the protruded area has the same diameter as the convex surface.

13. The method of claim 11, wherein the convex contact lens mount further comprises a layer positioned on the protruded edge, wherein the layer is operational to facilitate the mounting of the pre-manufactured contact lens on the convex surface.

14. The method of claim 10, further comprising a step of aligning the pre-manufactured contact lens on the convex contact lens mount.

15. The method of claim 14, wherein the aligning occurs by interferometry.

16. The method of claim 15, wherein the interferometry is performed by an interferometer comprising a laser source, a beam splitting optical assembly, a prism optical assembly, and a projection lens optical assembly.

17. The method of claim 1, wherein the altering comprises removing material from the pre-manufactured contact lens.

18. The method of claim 17, wherein the removal comprises removing a layer from the pre-manufactured contact lens surface.

19. The method of claim 1, wherein the altering comprises:
inserting the contact lens mount into an ophthalmic contact lens lathe, and
utilizing the ophthalmic contact lens lathe to alter one or more optical properties of the pre-manufactured contact lens.

20. The method of claim 1, wherein the mounting comprises dehydrating the pre-manufactured contact lens onto the contact lens mount.

21. The method of claim 20, wherein the pre-manufactured contact lens is a soft contact lens.

22. The method of claim 1, wherein the mounting comprises the use of vacuum.

23. The method of claim 1, wherein the mounting comprises the use of wax.

24. The method of claim 1, further comprising a step of removing the customized contact lens from the contact lens mount.

25. The method of claim 24, wherein the removal occurs by rehydrating a dehydrated contact lens.

26. The method of claim 24, wherein the removal occurs by removal or reduction of vacuum.

27. The method of claim 24, wherein the removal occurs by dissolution or melting of the wax.

28. The method of claim 1, wherein the pre-manufactured contact lens is a soft contact lens.

29. The method of claim 1, wherein the pre-manufactured contact lens is a rigid contact lens.

30. The method of claim 29, wherein the rigid contact lens is a scleral lens.

31. The method of claim 29, wherein the rigid contact lens is a corneal lens.

32. The method of claim 1, further comprising a step of selecting the pre-manufactured contact lens to be conformed.

33. A system for customizing a contact lens, wherein the system comprises:
a convex contact lens mount comprising:
a base area operational for anchoring the contact lens mount; and
a convex surface operational to mount the contact lens, wherein the convex surface comprises a curvature that matches a curvature of the contact lens.

34. The system of claim 33, wherein the base area is in the form of a cylindrical shaft.

35. The system of claim 33, wherein the base area is insertable into a contact lens lathe.

36. The system of claim 33, further comprising a protruded area positioned between the base area and the convex surface, wherein the protruded area comprises a protruded edge that surrounds the convex surface.

37. The system of claim 36, wherein the protruded area is in the form of a cylindrical shaft.

38. The system of claim 36, wherein the protruded area has a diameter larger than the diameter of the base area.

39. The system of claim 36, wherein the protruded area has the same diameter as the convex surface.

40. The system of claim 36, further comprising a layer positioned on the protruded edge, wherein the layer is operational to facilitate the mounting of the contact lens on the convex surface.

41. The system of claim 40, wherein the layer is in the form of a ring.

42. The system of claim 33, wherein the system further comprises an interferometer, wherein the interferometer is operational to align the contact lens on the convex contact lens mount by interferometry.

43. The system of claim 33, wherein the system further comprises an algorithm operable to construct a digital model of the contact lens on the convex contact lens mount.

44. The system of claim 43, wherein the algorithm comprises programming instructions for altering the digital model to incorporate a proposed correction for a user's residual eye aberrations and integrating the proposed correction into a digital description of the modified anterior or posterior surface of the contact lens.

45. The system of claim 43, wherein the digital model of the surface profile of the pre-manufactured contact lens is constructed by contact scanning, non-contact scanning, prior knowledge of the surface profile, or combinations thereof.

46. The system of claim 43, wherein the algorithm comprises programming instructions for receiving scanned surface data and transforming the data into a format that is processable by an ophthalmic contact lens lathe.

47. The system of claim 46, further comprising an ophthalmic contact lens lathe in electrical communication with the algorithm, wherein the ophthalmic contact lens lathe is operable to receive scanned and transformed surface data from the algorithm and alter one or more optical properties of the contact lens on the convex contact lens mount.
